(19) United States
(12) Patent Application Publication
(10) Pub. No.: US 2025/0367740 A1
(43) Pub. Date: Dec. 4, 2025

(54) HAND-HELD CONNECTOR MILLING MACHINE AND METHOD

(71) Applicant: Festool GmbH, Wendlingen (DE)

(72) Inventors: Benjamin ALLGAIER, Römerstein (DE); Vitus ROMMEL, Lenningen (DE); Matthias TENTER, Esslingen am Neckar (DE)

(21) Appl. No.: 18/873,631

(22) PCT Filed: Jun. 12, 2023
(86) PCT No.: PCT/EP2023/065673

§ 371 Date: Dec. 10, 2024

(30) Foreign Application Priority Data
Jun. 10, 2022 (DE) 10 2022 205 896.8

(51) Int. Cl. B23C 1/20

(52) U.S. Cl. CPC B23C 1/20

(57) ABSTRACT

A hand-held connector milling machine for producing a recess in a workpiece, the recess having a connector hole for receiving at least part of a connector. The connector milling machine includes: an electrical positioning device which is designed to move the milling tool along at least two positioning degrees of freedom, that are in particular linear, relative to the bearing structure; and an electronic control unit which is designed to control the electrical positioning device according to movement information so that the electrical positioning device displaces the milling tool in a movement sequence defined by the movement information along the at least two positioning degrees of freedom, while the milling tool performs a rotational removal movement in order to produce the recess which has the connector hole and a predefined recess geometry.

The invention relates to a hand-held connector milling machine for creating a recess in a workpiece, wherein the recess comprises a connector hole for the at least partial receiving of a connector. The connector milling machine for example is a dowel milling machine, in particular a flat dowel milling machine. The connector hole in particular is a dowel hole for inserting a dowel, in particular a flat dowel or a round dowel. The connector hole for example is an elongate hole. The connector milling machine comprises a handle for gripping the connector milling machine and for positioning the connector milling machine relative to the workpiece

An object of the invention lies in providing a flexibly usable connector milling machine.

The object is achieved by a connector milling machine according to claim 1.

The connector milling machine comprises a contact device with a contact structure for the stationary bearing contact of the connector milling machine on the workpiece during the creation of the recess, a milling tool, an electrical drive device which is designed to bring the milling tool into a rotative material-removing movement, an electrical positioning device which is designed to displace the milling tool relative to the contact structure along at least two, in particular linear positioning degrees of freedom, and an electronic control unit which is designed to control the electrical positioning device according to movement information such that the electrical positioning device brings the milling tool into a movement sequence which is defined by the movement information, along the at least two positioning degrees of freedom whilst the milling tool carries out the rotative material-removing movement, in order to create the recess with the connector hole with a defined recess geometry.

The recess geometry in particular is defined by the movement sequence, preferably at least with regard to the at least two positioning degrees of freedom.

Concerning the described connector milling machine, the recess geometry of the recess to be created is determined by the movement information. The recess comprises the connector hole and can preferably consist exclusively of the connector hole. Moreover, the recess additionally to the connector hole can comprise one or more further cut-outs, for example an access hole to the connector hole. The movement information in particular determines the connector hole geometry of the connector hole to be created. In particular, the connector milling machine is a (hand-held) CNC machine and can also be denoted as a (hand-held) CNC connector milling machine. The recess geometry of the recess to be created can be adapted in a simple manner by way of suitably adapted movement information, in particular in a manner such that different recesses, in particular different connector holes (for example for different connectors) can be created with the connector milling machine.

Advantageous further developments are the subject-matter of the dependent claims.

The invention further relates to a method for the operation of the hand-held connector milling machine, comprising the steps:
positioning the connector milling machine on the workpiece, so that the connector milling machine bears with the contact structure on the workpiece in a stationary manner during the creation of the recess,
controlling the electrical positioning device according to the movement information, so that the electrical positioning device brings the milling tool into the movement sequence whilst the milling tool carries out the rotative material-removing movement, in order to create the recess which comprises the connector hole, with the recess geometry which is defined by the movement sequence.

Expediently, the method is designed in accordance with a described embodiment of the hand-held connector milling machine.

Further exemplary details as well as exemplary embodiments are explained hereinafter with reference to the figures. Herein are shown in:

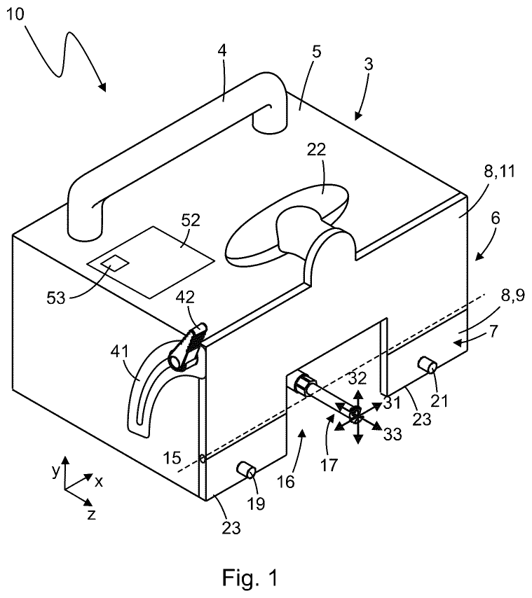

FIG. 1 a perspective representation of a hand-held connector milling machine according to a first embodiment,

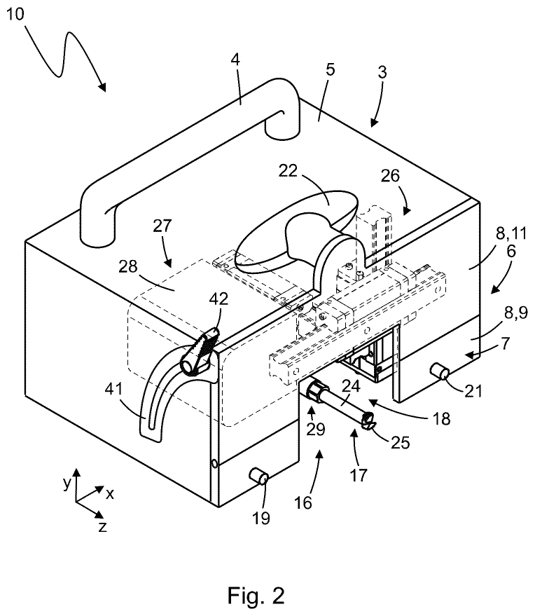

FIG. 2 a further perspective representation of the hand-held connector milling machine, wherein a drive device which is located within a housing and a positioning device are represented by dashed lines,

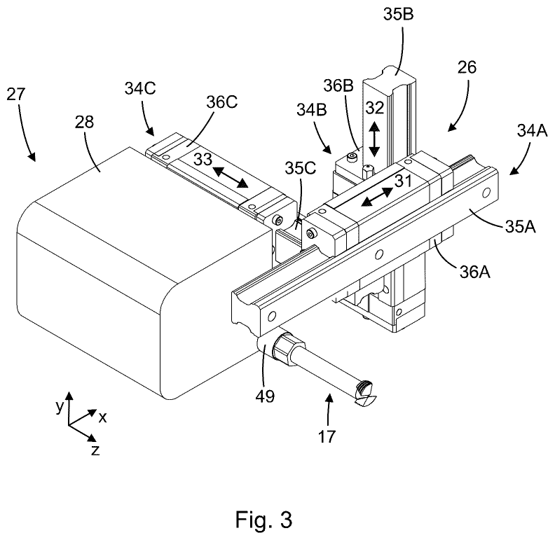

FIG. 3 a construction of the drive device, positioning device and a milling tool of the hand-held connector milling machine,

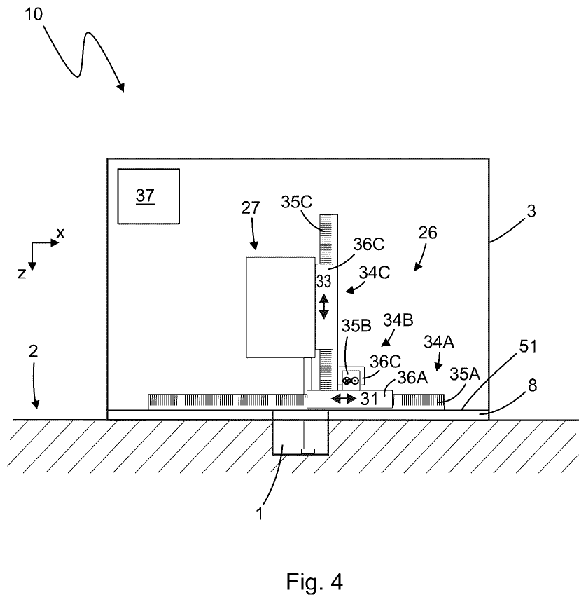

FIG. 4 a schematic sectioned view of the connector milling machine from above,

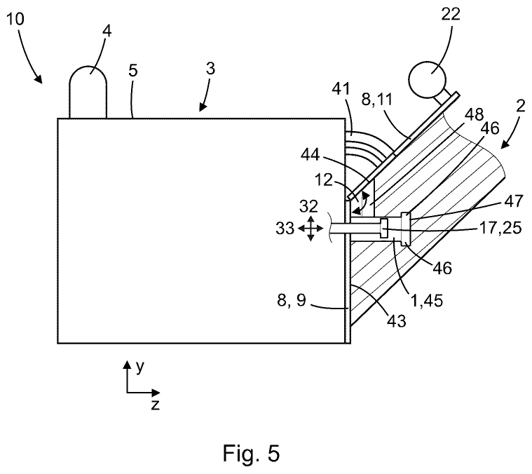

FIG. 5 a schematic lateral view of the connector milling machine, wherein the connector milling machine is applied onto a workpiece,

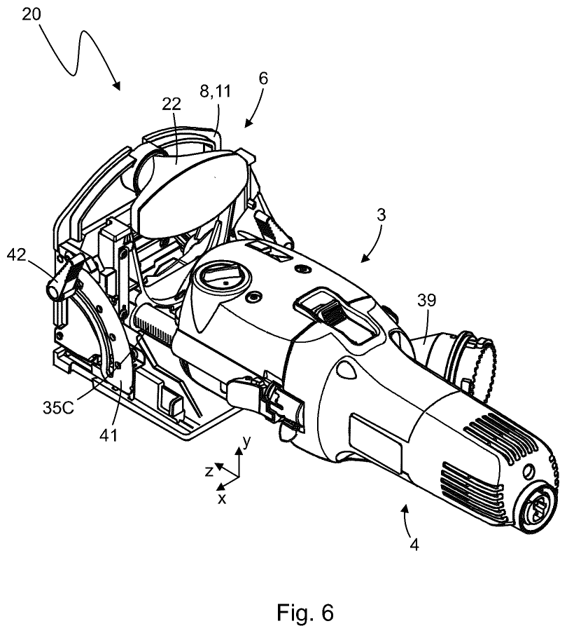

FIG. 6 a perspective representation of a hand-held connector milling machine according to a second embodiment,

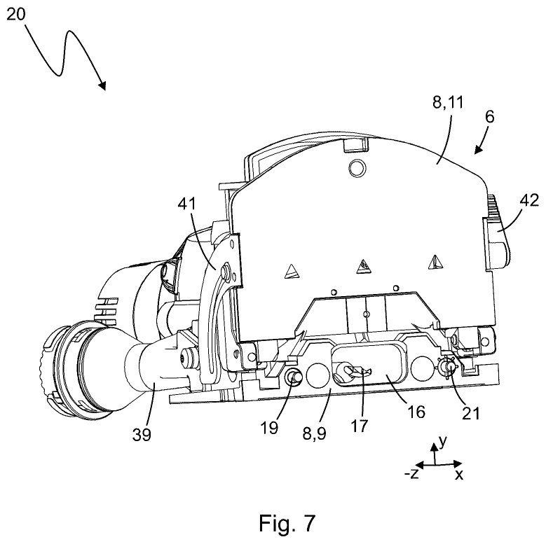

FIG. 7 a further perspective representation of the connector milling machine according to the second embodiment,

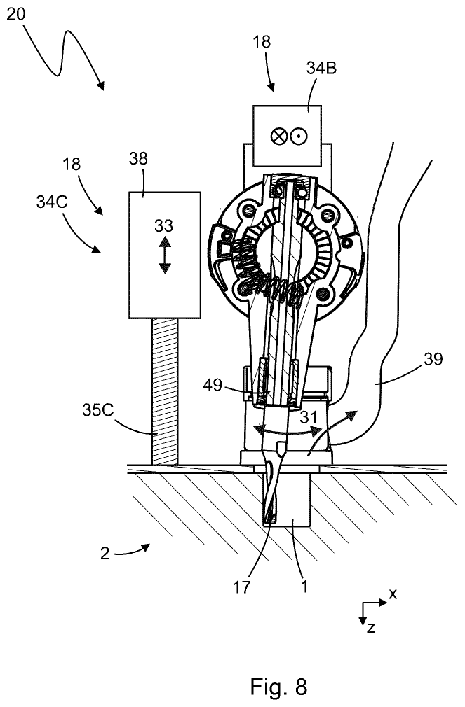

FIG. 8 a sectioned view of the connector milling machine according to the second embodiment from below, and

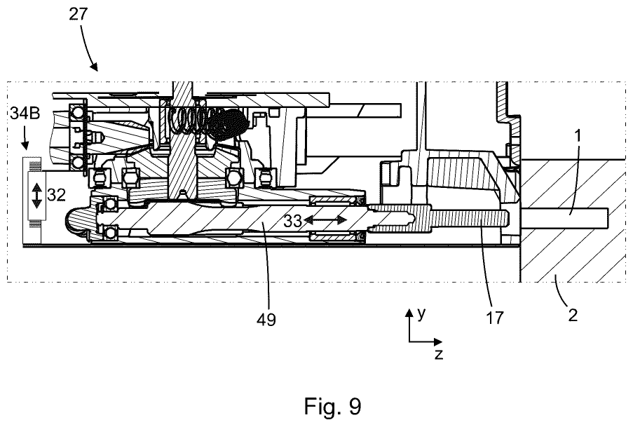

FIG. 9 a sectioned view of the connector milling machine according to the second embodiment from the side,

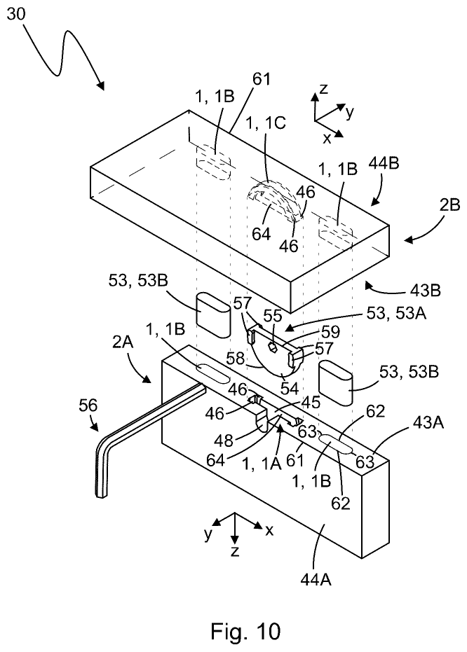

FIG. 10 a workpiece arrangement in an exploded representation with two workpieces, a rotary connector and two flat dowels,

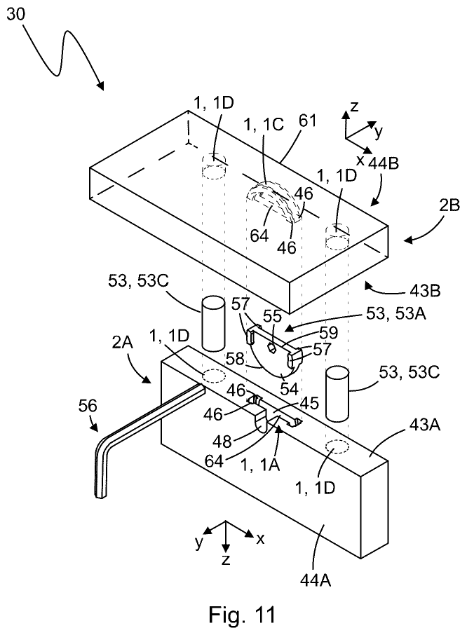

FIG. 11 a workpiece arrangement in an exploded representation with two workpieces, a rotary connector and two round dowels,

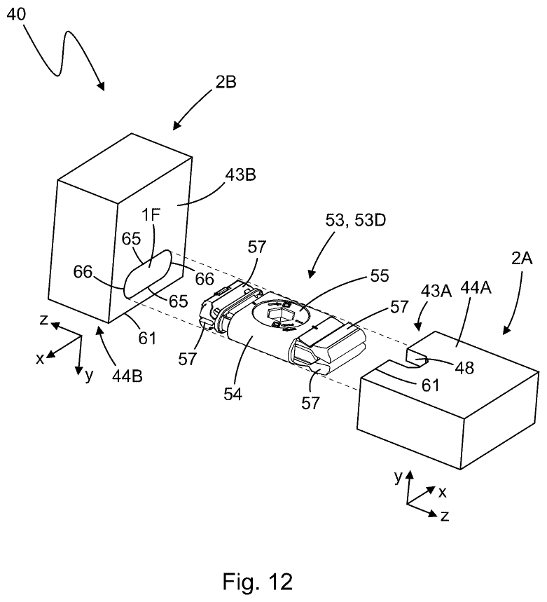

FIG. 12 a workpiece arrangement in an exploded representation with two workpieces and a kinematic connector,

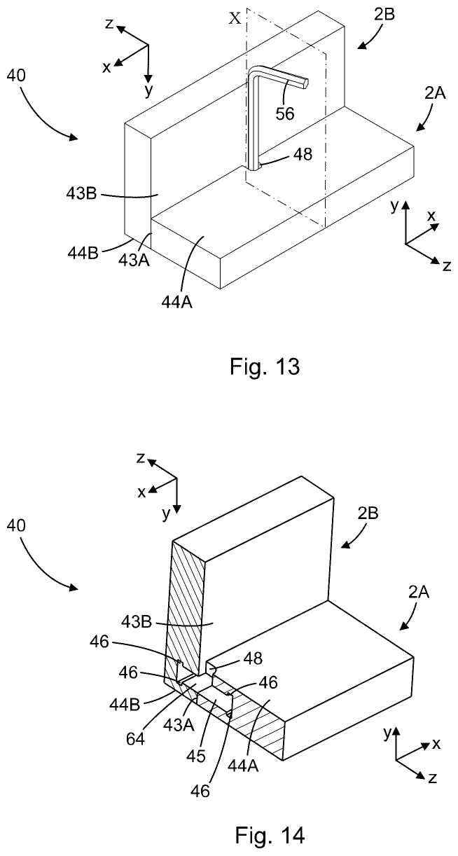

FIG. 13 a workpiece arrangement in an assembled state,

FIG. 14 a perspective sectioned representation of the workpiece arrangement in the assembled state, wherein the section runs through the section plane X which is shown in FIG. 13, and no connector is shown,

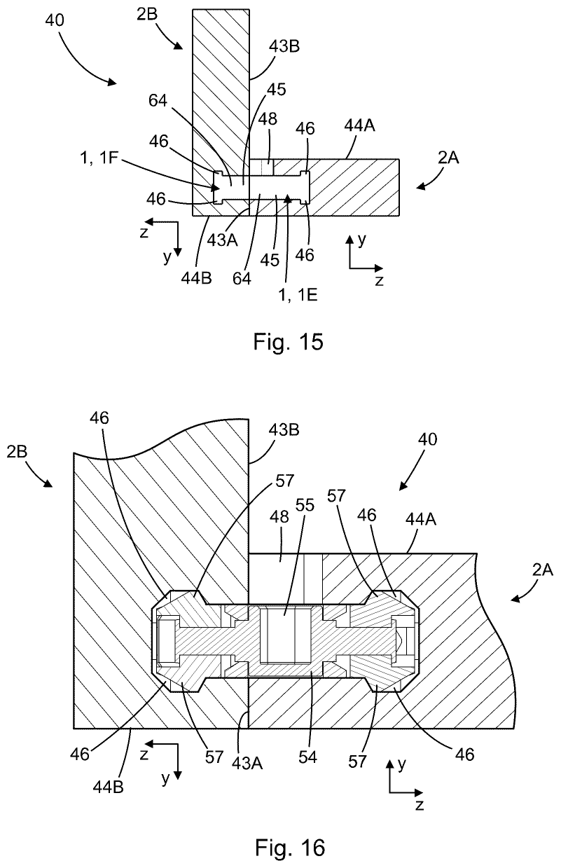

FIG. 15 a lateral view of the sectioned representation,

FIG. 16 a detailed view of the sectioned representation, wherein a connector is shown.

Concerning the subsequent details, one refers to the three spatial directions, the x-direction, y-direction and z-direction which are aligned orthogonally to one another. The x-direction is also to be denoted as the width direction x, the y-direction as the transverse direction y and the z-direction as the depth direction z. These directions relate to a connector milling machine 10 and accordingly given a rotation of the connector milling machine 10 also rotate with this. The depth direction z expediently runs in the direction of a rotation axis of a rotative material-removing movement of a milling tool 17 of the connector milling machine 10. The width direction x and the transverse direction y each run orthogonally to the rotation axis of the rotative material-removing movement.

FIG. 1 shows an exemplary design of the hand-held connector milling machine 10 according to a first embodiment. The connector milling machine 10 serves for creating a recess 1 in a workpiece 2 (see e.g. FIG. 4). The recess 1 comprises a connector hole 45 for the at least partial receiving of a connector 53. In particular, what is meant by the term “hand-held connector milling machine” is that the complete connector milling machine is held by hand by a user during the creation of the recess 1. The connector milling machine 10 in particular is dimensioned and/or designed in a manner such that the complete connector milling machine 10 can be carried by hand by a single person. For example, the connector milling machine 10 weighs less than 20 kg or less than 15 kg or less than 10 kg or less than 5 kg.

The connector milling machine 10 comprises a housing 3 which in particular represents the outer housing of the connector milling machine 10. The housing 3 by way of example has a cuboid basic shape.

The connector milling machine 10 comprises a handle 4 which by way of example is arranged on a first side 5 of the connector milling machine 10. The first side 5 can also be denoted as the handle side and by way of example is aligned orthogonally to the transverse direction y. The first side 5 by way of example is formed by a wall of the housing 3. The handle 4 serves for gripping the connector milling machine 10 and for positioning the connector milling machine 10 relative to the workpiece 2. The handle 4 by way of example is designed in a bow-like manner. By way of example, the handle 4 is aligned with its longitudinal axis parallel to the width direction x. Alternatively, the handle 4 with its longitudinal axis can be aligned parallel to the depth direction z. Moreover, the handle can also be designed differently. The handle 4 is preferably designed in an integral manner with the housing 3.

The extension of the housing 3 (in particular without taking into account any handles of the connector milling machine 10) in the width direction x is preferably greater than the extension of the housing 3 (in particular without taking into account any handles of the connector milling machine 10) in the depth direction z. The extension of the connector milling machine 10 without taking into account any handles of the connector milling machine 10 is preferably greater in the width direction x than in the depth direction z.

The connector milling machine 10 comprises a contact device 6 which by way of example is present on a second side 7 of the connector milling machine 10. The second side 7 can also be denoted as the contact side and by way of example is aligned orthogonally to the depth direction z. The contact device 6 comprises a contact structure 8 for the stationary bearing contact of the connector milling machine 10 on the workpiece 2 during the creation of the recess 1. By way of example, the contact structure comprises a first structure section 9 and a second structure section 11. The second structure section 11 by way of example connects onto the first structure section 9 in the transverse direction y. The first structure section 9 and the second structure section 11 serve for the simultaneous stationary bearing contact on the workpiece 2 during the creation of the recess 1. The first structure section 9 defines a first contact plane and the second structure section 11 defines a second contact plane. For example, the first structure section 9 comprises a first contact surface which defines the first contact plane and/or the second structure section 11 comprises a second contact surface which defines the second contact plane. Expediently, the connector milling machine 10 bears with the contact structure 8, in particular simultaneously with the first contact plane and the second contact plane, on the workpiece 2 during the creation of the recess 1, in particular during the complete creation of the recess 1. The first contact plane by way of example is aligned orthogonally to the depth direction z and preferably is permanently fixed in this alignment, in particular in a manner such that the alignment of the first contact plane cannot be changed.

The second structure section 11 is pivotably mounted relative to the first structure section 9, in particular about an (imagined) pivot axis 15 which is preferably aligned parallel to the x-axis. The second structure section 11 is preferably pivotable about the pivot axis 15 which is aligned orthogonally to the rotation axis of the material-removing movement of the milling tool 17 of the connector milling machine 10. The pivot axis 15 by way of example is located between the first structure section 9 and the second structure section 11 in the transverse direction y. By way of example, the contact device 6 comprises a pivot bearing which defines the pivot axis 15.

The second structure section 11 can be fixed relative to the first structure section 9 in a plurality of different pivot positions, in order to set an fixed angle 12 which in particular is adapted to the workpiece 2, between the first contact plane and the second contact plane (see e.g. FIG. 5) In particular, the angle 12 lies in a z-y plane. The second contact plane can be pivoted relative to the first contact plane (and in particular relative to the depth direction z) by way of a pivoting (about the pivot axis 15) of the second structure section 11 relative to the first structure section 9. Preferably, the connector milling machine 10 comprises a fixation device by way of which the second structure section 11 can be fixed relative to the first structure section 9 in each of the plurality of different pivot positions, for example by way of a non-positive and/or positive fit. By way of example, the fixation device comprises at least one structure section guide element 41 which is preferably designed as a slotted guide. By way of example, the at least one structure section guide element 41 is fastened to the second structure section 11 and is preferably co-pivoted with this about the pivot axis 15. Preferably, the at least one structure-section guide element 41 defines the pivot axis 15 or contributes to the definition of the pivot axis 15. The at least one structure section guide element 41 in particular can be a part of the pivot bearing. The fixation device preferably comprises an actuation element 42 which by way of example is designed as a lever and via whose action the second structure section 11 can be fixed in its current pivot position relative to the first structure section 9, for example by way of a non-positive fit and/or positive fit, in particular by way of at least one structure section guide element 41 being fixed in its current pivot position relative to the first structure section 9, for example with a non-positive fit and/or positive fit, by way of the actuation element 2.

In particular, the second structure section 11 can be pivoted into a first pivot position in which the second contact plane expediently lies in the same plane as the first contact plane. The angle 12 in particular is 180 degrees in the first pivot position. In the first pivot position, the second structure section 11 is aligned orthogonally to the depth direction z (see e.g. FIG. 1). Preferably, the first pivot position is an end position of the second structure section 11. Coming from the first pivot position, the second structure section 11 is pivotable about the pivot axis 15 in order to reduce the angle 12, in particular at least to an angle 12 of 90 degrees or smaller than 90 degrees. The second structure section 11 in particular can be brought into a second pivot position in which the angle 12 is less than 180°, for example 90 degrees or less than 90 degrees.

By way of example, the first structure section 9 and/or the second structure section 11 are designed in a plate-like manner. The contact device 6 can also be denoted as a contact table. The first structure section 9 by way of example comprises a first contact part 13 and a second contact part 14 which in particular are designed in a plate-like manner and/or are arranged distanced to one another. The first contact part 13 and the second contact part 14 together define the first contact plane and expediently both simultaneously bear on the workpiece 2 on creation of the recess.

By way of example, the contact device 6 comprises a first contact projection 19 and/or a second contact projection 21 which by way of example are arranged on the first structure section 11, in particular on the first contact part 13 and the second contact part 14 and preferably coming from the first structure section 1 extend in the depth direction z. Expediently, on creating the recess 1, the connector milling machine 10 can be applied with at least one of the contact projections 19, 21 in a direction orthogonal to the depth direction z. The contact projections 19, 21 are expediently movably mounted relative to the first contact plane and in particular can be brought into a retracted state in which the contact projections 19, 21 expediently do not project out of the first contact plane and/or into an extended state in which the contact projections 19, 21 expediently project out of the first contact plane.

The contact structure 8 preferably comprises an opening 16. By way of example, the opening 16 is located between the two contact parts 13, 14 in the width direction x. By way of example, the milling tool 17 extends through the opening 16 from an interior 18 (in particular surrounded by the housing 3) to outside the connector milling machine 10, in particular the housing 3. The milling tool 17 can be positioned within the opening 16 by way of an electrical positioning device 18 of the connector milling machine 10, in particular along at least two of positioning degrees of freedom 31, 32, 33. The opening 16 by way of example has an elongate and/or rectangular cross section. The opening 16 is aligned with its opening plane orthogonally to the depth direction z.

The opening 16 preferably extends over the first structure section 9 and the second structure section 11. The opening 16 is expediently present in the first structure section 9 (by way of example between the first contact part 13 and the second contact part 14) and from there extends (by way of example in the transverse direction y) into the second structure section 12. By way of example, the opening 16 is sectioned by the (imagined) pivot axis 15. By way of example, the pivot axis 15 intersects a displacement region of the milling tool 17, in particular an x-y displacement region or x-y-z displacement region. The displacement region is formed by at least two or three positioning degrees of freedom 31, 32, 33 which are provided by the positioning device 18. For example, the displacement region is a plane, in particular an x-y plane or a volume, in particular an x-y-z volume, within which plane or volume the milling tool 17 can be positioned by way of the positioning device 18.

By way of example, the opening 16 extends (in particular in the negative transverse direction y) up to a first structure section edge 23 of the first structure section 9 which is away from the second structure section 11, and expediently runs out at this edge 23 in the negative transverse direction y. According to an alternative design, the opening 16 does not extend up to the first structure section edge 23, so that an in particular web-like section runs from the first contact part 13 to the second contact part 14 in the negative transverse direction y below the opening 16.

By way of example, the connector milling machine 10 comprises a contact structure handle 22 which is arranged on the second structure section 11 and via which expediently the second structure section 11 is pivotable relative to the first structure section 9. By way of example, the contact structure handle 22 is designed in a knob-like manner. Moreover, the contact structure handle can be designed in a bow-like manner. For example, the user can hold the connector milling machine 10 with one hand held on the handle 4 and simultaneously with the other hand hold the contact structure handle 22. Preferably, the contact structure handle 22 is aligned with its handle axis parallel to the width direction x. That (imagined) axis of the contact structure handle 22 which the user embraces on (in particular designated) gripping the contact structure handle 22 is denoted as the handle axis.

The connector milling machine 10 comprises the milling tool 17 which in particular is designed as a groove miller, preferably as a T-groove miller. The milling tool 17 in particular is designed as an undercut miller. A miller with which the recess 1, in particular the connector hole 45 can be created with an undercut, in particular an undercut which acts along a direction parallel to the rotation axis of the material-removing movement is to be denoted as an undercut miller. The milling tool 17 for example can be designed as a hollow fillet miller. Moreover, the milling tool 17 can be designed as a drill or drill miller in particular when the recess 1 which is to be created, in particular the connector hole 45, has no undercut. The milling tool 17 by way of example comprises a shank section 24 as well as a milling head 25 which is arranged at one end of the shank section 24. By way of example, the shank section 24 is aligned with its longitudinal axis in the depth direction z.

The connector milling machine 10 comprises an electrical drive device 27 which is designed to bring the milling tool 17 into a rotative material-removing movement. The rotation axis of the rotative material-removing movement is expediently aligned in the depth direction z. The electrical drive device 27 comprises for example an electric motor 28 in order to bring the milling tool 17 into the rotative material-removing movement. Expediently, the drive device 27 comprises a tool interface 29 onto which the milling tool 17 is attached. For example, the tool interface 29 comprises an outer thread and the milling tool 17 comprises an inner thread with which the milling tool 17 can be screwed onto the outer thread. The outer thread is preferably arranged on a spindle 49 of the drive device 27.

The connector milling machine 10 comprises the electrical positioning device 26 which is designed to displace the milling tool 17 relative to the contact structure 8 along at least two in particular linear positioning degrees of freedom 31, 32, 33. Inasmuch as one speaks of positioning degrees of freedom, it is always the degrees of freedom of the electrical positioning device 26 which are meant by this. In particular, the positioning degrees of freedom 31, 32, 33 are those degrees of freedom, along which a position which is set by an electronic control unit 37 of the connector milling machine 10 can be moved to by way of the electric positioning device 26. In particular, a positioning according to an (in particular arbitrary) desired position which is specified by the control unit 37 is possible along the positioning degrees of freedom 31, 32, 33 by way of the positioning device 26. The desired position expediently defines a respective desired position value for each positioning degree of freedom 31, 32, 33.

Preferably, the positioning device 26 is designed to displace the milling tool relative to the contact structure 8 along three in particular linear positioning degrees of freedom 31, 32, 33, wherein the three positioning degrees of freedom 31, 32, 33 are preferably aligned orthogonally to one another. Preferably, one of the positioning degrees of freedom, in particular a first positioning degree of freedom 31 runs orthogonally to the rotation axis of the material-removing movement and/or parallel to a contact plane which is defined by the contact structure 8, in particular to the first contact plane. In particular, the first positioning degree of freedom 31 runs in the width direction x. Preferably, one of the positioning degrees of freedom, in particular second positioning degree of freedom 32 runs in the transverse direction y, thus in particular orthogonally to the first positioning degree of freedom 31 and/or to the rotation axis of the material-removing movement. Preferably, one of the positioning degrees of freedom, in particular a third positioning degree of freedom 33 runs in the axis direction of the rotation axis of the material-removing movement and/or orthogonally to a contact plane which is defined by the contact structure, in particular to the first contact plane. In particular, the third positioning degree of freedom 33 runs in the depth direction z.

By way of example, the positioning device 26 comprises three linear axes which are aligned orthogonally to one another for providing the positioning degrees of freedom 31, 32, 33. Preferably, the positioning device 26 comprises three linear drives 34A, 34B, 34C which in particular serve for providing the three linear axes. Each of the linear drives 34A, 34B, 34C expediently comprises a respective electrical motor. The three linear drives 34A, 34B, 34C comprise a first linear drive 34A, a second linear drive 34B and a third linear drive 34C.

The first linear drive 34 comprise a first guide element 35A, in particular a first guide rail which is aligned with its longitudinal axis by way of example in the width direction x. The first linear drive 34A comprises a first drive element 36A, in particular a first slide, which is mounted on the first guide element 35 A and which can be electrically driven relative to the first guide element 35A along a first positioning degree of freedom 31 by way of the first linear drive 34A. Preferably, the first slide engages around the first guide rail and in particular is positively held on this, so that the first slide expediently can only be displaced in the direction of the first positioning degree of freedom 31. For example, the first guide rail has an X-profile, around which the first slide engages at three sides.

The second linear drive 34B comprises a second guide element 35B, in particular a second guide rail which is aligned with its longitudinal axis by way of example in the transverse direction y. The second linear drive 34B comprises a second drive element 36B, in particular second slide, which is mounted on the second guide element 35B and can be electrically driven relative to the second guide element 35B along the second positioning degree of freedom 32 by way of the second linear drive 34B. Preferably, the second slide engages around the second guide rail and in particular is positively held on this, so that the second slide can be displaced expediently only in the direction of the second positioning degree of freedom 32. For example, the second guide rail has an X-profile, around which the second slide engages at three sides.

The third linear drive 34C comprises a third guide element 35C, in particular a third guide rail which with its longitudinal axis is aligned by way of example in the depth direction z. The third linear drive 34C comprises a third drive element 36C, in particular a third slide, which is mounted on the third guide element 35C and which can be electrically driven relative to the third guide element 35C along the third positioning degree of freedom 33 by way of the third linear drive. Preferably, the third slide engages around the third guide rail and in particular is positively held on this, so that the third slide can be displaced expediently only in the direction of the third positioning degree of freedom 33. For example, the third guide rail has an X-profile, around which the third slide engages at three sides.

By way of example, the drive device 27 is fastened to the third linear drive 34C, in particular to the third drive element 36C, so that the drive device 27 (and by way of this the milling tool 17) is positionable along the third positioning degree of freedom 33 by the third linear drive 34C. By way of example, the third linear drive 34C (in particular with the third guide element 35C) is fastened to the second linear drive 34B, in particular to the second drive element 36B, so that the third linear drive (and by way of this the drive device 27 with the milling tool 17) is positionable along the second positioning degree of freedom 33 by the second linear drive 34B. By way of example, the second linear drive 34B (in particular with the first guide element 35A) is fastened to the first linear drive 34A, in particular to the first drive element 36A, so that the second linear drive 34B (and by way of this the third linear drive 34C as well as the drive device 27 with the milling tool 17) is positionable along the first positioning degree of freedom 31 by way of the first linear drive 34A.

By way of example, the first linear drive 34A, in particular the first guide element 35A is arranged at the inside on the contact side 7, in particular on a wall 51 of the connector milling machine 10 which in faces the contact side 7. By way of example, the first linear drive 34A, in particular the first guide element 35A is arranged further in the (positive) transverse direction y than the opening 16. In other words, the first linear drive 34A, in particular the first guide element 35A by way of example is arranged in the transverse direction y, between the opening 16 and the first side 5. In an alignment of the connector milling machine 10, in which the transverse direction y is aligned vertically and points upwards, the first linear drive 34A, in particular the first guide element 35A is arranged above the opening 16. The connector milling machine 10, in particular the housing 3 comprises the wall 51 which is assigned to the contact y side 7 and which by way of example is aligned orthogonally to the depth direction z. The contact device 6 is arranged at the outside on the wall 51 (thus by way of example on the side which is aligned in the positive depth direction z) and the first linear drive 34A is arranged at the inside on the wall 51 (by way of example on the side which is aligned in the negative z direction).

Preferably, a maximal displacement path for the positioning of the milling tool 17 along the positioning degree of freedom 31 which runs in the width direction x is at least 1.3 cm and/or a maximal displacement path for the positioning of the milling tool along the positioning degree of freedom 32 which runs in the transverse direction y is at least 0.4 cm and/or a maximal displacement path for the positioning of the milling tool along the positioning degree of freedom 33 which runs in the depth direction z is at least 1.1 cm.

Preferably, the maximal displacement path of the milling tool 17 along the second positioning degree of freedom 32 is at least 20%, at least 50% or at least 70% of the maximal displacement path of the milling tool 17 along the first positioning degree of freedom 31.

According to a possible design, the maximal displacement path of the milling tool 17 along the first positioning degree of freedom 31 is at least 6 cm and/or the maximal displacement path of the milling tool 17 along the second positioning degree of freedom 32 is at least 5 cm and/or the maximal displacement path of the milling tool 17 along the third positioning degree of freedom 32 is at least 4 cm.

According to a further possible design, the maximal displacement path of the milling tool 17 along the first positioning degree of freedom 31 is 7.6 cm and/or the maximal displacement path of the milling tool 17 along the second positioning degree of freedom 32 is 2.9 cm and/or the maximal displacement path of the milling tool 17 along the third positioning degree of freedom 33 is 4.5 cm.

The connector milling machine 10 comprises the electronic control unit 37 which for example has a microprocessor, in particular a microcontroller and is preferably designed as a microcontroller. The control unit 37 is designed to control the electrical positioning device 26 according to movement information, so that the electrical positioning device 26 brings the milling tool 17 into a movement sequence which is defined by the movement information, along the at least two positioning degrees of freedom 31, 32, 33 whilst the milling tool 17 carries out the rotative material-removing movement, in order to create the recess 1 which comprises the connector hole 45, with a specified depth geometry. What is meant by the term “recess geometry” is the geometry of the recess 1 to be created, thus in particular the dimensions and/or the shape of the recess 1 to be created, in particular of the connector hole 45, preferably in each of the positioning degrees of freedom 31, 32, 33. Preferably, the milling tool 17 carries out the rotative material-removing movement during at least a part of the movement sequence, optionally during the complete movement sequence. In particular, the milling tool 17 carries out the rotative material-removing movement (given the movement sequence) at least during a movement along the first positioning degree of freedom 31 and/or during a movement along the second positioning degree of freedom 32 and/or during a movement along the third positioning degree of freedom 33.

The execution of the movement sequence which is defined by the movement information (whilst carrying out the rotative material-removing movement) is also to be denoted as creation procedure. The movement information is stored for example in the electronic control unit, for example as a file, and/or is received by the electronic control unit 37 and/or is generated by the electronic control unit 37. For example, the movement information defines a plurality of successive desired positions of the milling tool 17, in particular in each case with reference to the at least two positioning degrees of freedom 31, 32, 33. Preferably, the movement information for the milling tool defines a feed speed, feed direction and/or miller rotation speed, in particular for each movement of the milling tool between two successive desired positions.

Preferably, the movement information defines the movement sequence along the three positioning degrees of freedom 31, 32, 33 and the movement sequence specifies the recess geometry with respect to the three positioning degrees of freedom. For example, the movement information defines a plurality of successive desired positions of the milling tool 17, in particular each with respect to the three positioning degrees of freedom 31, 32, 33.

The electronic control unit 37 preferably comprises several different pieces of movement information. Each piece of movement information is assigned to a respective recess geometry. The recess geometries preferably differ from one another. The control unit 37 is designed to control the positioning device 26 according to one of the pieces of movement information in order to effect the creation of the recess 1 with the recess geometry which is assigned to this piece of movement information. What is meant by the wording that a recess geometry is assigned to a piece of movement information is that a recess 1 with the assigned recess geometry can be created by an execution of the creation procedure with this piece of movement information.

Optionally, the control unit 37 is designed to select the piece of movement information which is to be used for the creation of the recess 1 from amongst the present pieces of movement information, for example according to a user input and to control the positioning device 26 according to the selected pieces of movement information, in order to effect the creation of the recess 1 with the recess geometry which is assigned to the selected piece of movement information.

The connector milling machine 10 preferably comprises an operating device 52 which by way of example is arranged on the housing 3 at the outside. The operating device 52 comprises at least one operating element 53, for example a key for the operation of the connector milling machine 10. For example, the operating element 53 serves for starting the creation procedure for creating the recess 1.

Optionally, the user input for the selection of the piece of movement information which is to be used can be carried out via the operating device 52.

Optionally, the connector milling machine 10 comprises a suction channel, via which particles, in particular chippings which arise on creation of the recess 1 can be sucked away.

Hereinafter, a state in which the connector milling machine 10 bears on the workpiece 2 and with the milling tool 17 creates the recess in the workpiece 2 is dealt with in more detail with reference to FIG. 5.

The connector milling machine 10 bears with a first structure section 9, in particular the first contact plane, on a first workpiece surface 43, in particular in an extensive manner. The first workpiece surface by way of example is aligned orthogonally to the depth direction z. By way of example, the first workpiece surface 43 is a plane surface and in particular forms a plane first side of the workpiece 2. The first workpiece surface 43 in particular the first side of the workpiece 2 by way of example is shorter in the transverse direction y than the connector milling machine 10.

The connector milling machine 10 bears with the second structure section 11, in particular with the second contact plane, on a second workpiece surface 44, in particular in an extensive manner. By way of example, the second workpiece surface 44 is a plane surface and in particular forms a plane second side of the workpiece 2. The second workpiece surface 44 is angled relative to the first workpiece surface 43 and in particular is not aligned orthogonally to the depth direction z. The second workpiece surface 44 is not aligned parallel relative to the first workpiece surface 43.

The second structure section 11 is fixed in a pivot position in which a simultaneous (in particular extensive) bearing contact of the first contact plane on the first workpiece surface 43 and of the second contact surface on the second workpiece surface 44 is given. The angle 12 between the contact planes 11, 12 is set by the pivot position of the second structure section 11, preferably an angle smaller than 180 degrees and/or larger than 90 degrees.

The recess 1 to be created by way of example runs out at the first workpiece surface 43. Preferably, the recess 1 to be created runs out at the first workpiece surface 43 and at the second workpiece surface 44. On creating the recess, the positioning device 26 positions the milling tool 17 so far in the transverse direction y, until the milling tool 17, in particular the milling head 25 is situated in or on the part of the opening 16 which is present in the second structure section 11, in particular whilst the milling tool 17 carries out the material-removing movement. The recess 1 which runs out at the second workpiece surface 44 can be created in this manner (in particular without repositioning the connector milling machine 10).

Optionally, for creating the recess 1, the milling tool 17 can immerse through the second workpiece surface 44 from above. In particular, for this purpose the connector milling machine 10 can be designed to firstly move the milling tool 17 so far in the transverse direction y by way of the positioning device 26 whilst carrying out a positioning movement, until the milling tool 17 in particular the milling head 25, is situated in or on the part of the opening 16 which is present in the second structure section 11 and is preferably positioned further in the (positive) transverse direction y than the second workpiece surface 44 (or than a lower section of the second workpiece surface 44). Expediently, the milling tool 17 does not carry out the material-removing movement during this positioning movement, thus expediently does not rotate. The milling tool 17, in particular the milling head 25 is expediently situated outside, in particular in front of, the first workpiece surface 43 during this positioning movement. The connector milling machine 10 is preferably designed to bring the milling tool 17 into a material-removing movement after carrying out the positioning movement (and/or a further positioning movement of the milling tool 17 in the positive depth direction z) and, whilst the milling tool 17 carries out the material-removing moment, to move the milling tool 17 into the second workpiece surface 44 for creating the recess 1, in particular by way of a displacing of the milling tool 17 in the (negative) transverse direction y and/or the (positive) depth direction z, by way of the positioning device 26.

The recess 1 to be manufactured comprises the connector hole 45. A hole for the at least partial insertion of a connector is denoted as a connector hole 45. A connector is an element for connecting two workpieces. An example for a connector is a dowel, in particular a wooden dowel. The connector hole 45 in particular is a coupling groove.

The connector hole 45 preferably comprises an undercut 46 which acts along the depth direction z. The depth direction z is aligned parallel to the rotation axis of the material-removing movement. The depth direction z in particular is a groove depth direction. What is meant by the wording that the undercut 46 acts along the depth direction z is that the undercut 46 serves for preventing a connector which is inserted into the connector hole and is in engagement with the undercut 46 from being pulled out along the depth direction z (in particular in the negative depth direction z). The undercut 46 serves in particular for receiving an engagement projection 57 of a connector which is to be inserted into the connector hole. The undercut 46 is expediently a cut-out, in particular an elongate cut-out, for example a groove, wherein the longitudinal axis of the elongate cut-out is preferably aligned parallel to the width direction x. The undercut 46 is preferably arranged in the region of a connector hole base 47 of the connector hole. The connector hole base 47 is aligned for example orthogonally to the depth direction z and/or parallel to the transverse direction y. The connector hole 45 expediently runs out at the first workpiece surface 43, in particular exclusively at the first workpiece surface 43.

Preferably, the several pieces of movement information comprise a first piece of movement information which is assigned to a first recess geometry concerning which the connector hole 45 comprises an undercut 46 and second piece of movement information which is assigned to a second recess geometry concerning which the connector hole 45 has no undercut. An example for a connector hole 45 without an undercut is the subsequently described dowel recess.

Preferably, the movement sequence which is defined by the movement information specifies the connector hole 48 and an access hole 48 to the connector hole 45. The electronic control unit 37 is designed to control the electrical positioning device 26 according to the movement information, so that the electrical positioning device 26 brings the milling tool 17 into the movement sequence whilst the milling tool carries out the rotative material-removing movement, in order to create the connector hole 45 and the access hole 48, in particular during a single, continuous working procedure and in particular without resetting the connector milling machine 10.

By way of example, the recess 1 to be created comprises the access hole 48 to the connector hole 45. The access hole 48 by way of example, coming from the connector hole 45 runs in the transverse direction y up to the second workpiece surface 44, at which the access hole 48 runs out. By way of example, the access hole 48 runs out at the first workpiece surface 43 and at the second workpiece surface 44. The access hole 48 in particular serves for providing an access (in particular via the second workpiece surface 44) for the tool 56 to a connector which is inserted into the connector hole 45, so that for example the actuation element 55 of the connector can be actuated with the tool 56 whilst the connector is inserted into the connector hole 45.

Preferably, the geometry of the connector hole 45 and/or the access hole 48 is determined by the movement sequence which is defined by way of the movement information, in particular with respect to the three positioning degrees of freedom 31, 32, 33. The movement information in particular sets the extension of the connector hole 45 and/or the access hole 48 in the width direction x, the transverse direction y and/or the depth direction z.

The recess geometry which is assigned to the movement information expediently has a connector hole geometry and/or access hole geometry. Thus expediently a connector hole geometry of the connector hole 45 and/or access hole geometry of the access hole 48 are assigned to the movement information. What is mean by the wording that a connector hole geometry or an access hole geometry is assigned to movement information is that the assigned connector hole geometry or the assigned access hole geometry can be created by way of carrying out the creation procedure with this movement information.

Preferably, a recess without an undercut (e.g. the dowel recess which is explained hereinafter) and/or a recess with an undercut (i.e. the subsequently explained rotary connector recess 1A, 1C and/or kinematic connector recess 1E, 1F) and/or a recess with an access hole (e.g. the subsequently explained rotary connector recess 1A and/or kinematic connector recess 1E) and/or a recess without an access hole (e.g. the subsequently explained rotary connector recess 1C and/or kinematic connector recess 1F) and/or a recess with a circular-disc-shaped main section and undercut (e.g. the subsequently explained rotary connector recess 1A, 1C) can be selectively created by way of the connector milling machine 10.

Different recesses 1 which can preferably be created with the connector milling machine 10 are dealt with hereinafter with reference to FIGS. 10 to 16 (in particular as is explained above). Two workpieces 2A, 2B which each comprise at least one recess 1 are shown in the FIGS. 10 to 16. A respective coordinate system is drawn in the FIGS. 10 to 16 for each workpiece 2A, 2B, said coordinate system corresponding to a possible (or necessary) alignment of the connector milling machine 10 on creating one or more recesses 1 of the respectively assigned workpiece 2.

Expediently, during the (in particular complete) creation of the subsequently explained recesses 1, the connector milling machine 10 in a stationary manner bears with the contact structure 8, in particular simultaneously with both structure sections 9, 11 on the respective workpiece 2A, 2B, in which the recess 1 is created, in particular simultaneously with the first structure section 9 on the first workpiece surface 43A and with the second structure section 11 on the second workpiece surface 44A (or simultaneously with the first structure section 9 on the first workpiece surface 43B and with the second structure section 11 on the second workpiece surface 44B).

FIG. 10 shows a workpiece arrangement 10 which comprises a first workpiece 2A and a second workpiece 2B as well as a connector 54 which by way of example is designed as a rotary connector 53A. Optionally, the workpiece arrangement 30 further comprises two further connectors 53 which are designed as dowels, by way of example as flat dowels 53B. Alternatively, the further connectors 53 can also be designed as round dowels 53C as is shown in FIG. 11.

The rotary connector 53A comprises a connector body 54 which by way of example has the shape of a circular disc section and preferably comprises two circular segmental main sides. The main sides are arranged parallel to one another. The outer contour of each of the main sides has a circular arc section 58 and a circular chord section 59 which connects the two ends of the circular arc section 58. The connector bodies 54 comprise an actuation section 55 which by way of example is designed as an in particular hexagonal cut-out and is expediently present concentrically to the circular arc section 58 in at least one of the main sides. A tool 56 which by way of example is designed as an internal hex can be inserted into the actuation section 55. The rotary connector 53A comprises engagement projections 57 which project perpendicularly from the connector body 54 from each main side and by way of example are arranged at the ends, in particular exclusively at the ends, of the respective circular arc section 58. By way of example, four engagement projections 57 are present, wherein each engagement projection 57 is arranged at a respective end of a circular arc section 58.

The dowels which by way of example are designed as flat dowels 53B each have the shape of a cylinder, by way of example with a base surface whose outer contour comprises two straight-lined sections which run in parallel another and two rounded, in particular circular arc shaped end sections which connect the two straight-lined sections. The round dowels 53C each have the shape of a circular cylinder.

The first workpiece 2A comprises a first workpiece surface 43A in which by way of example three recesses 1 are present, and specifically a connector recess, in particular a rotary connector recess 1A for the partial receiving of a connector, in particular of the rotary connector 53A, as well as optionally two dowel recesses, in particular flat dowel recesses 1B, for the partial receiving of a respective dowel, in particular a flat dowel 53B. Alternatively, the dowel recesses can be designed as round dowel recesses 1D (cf. FIG. 11). Each dowel recess represents a recess with a connector hole. In particular, each dowel recess represents a connector hole. The connector recess by way of example comprises the connector hole 45 and the access hole 48. The first workpiece 2A further comprises a second workpiece surface 44A which by way of example is aligned orthogonally to the first workpiece surface 43A and is connected to the first workpiece surface 43 A in particular via a common edge 61.

The second workpiece 2B comprises a first workpiece surface 43B in which by way of example three recesses 1 are present, and specifically a connector recess 1, in particular a rotary connector recess 1C, for the partial receiving of a connector, in particular of the rotary connector 53A, as well as optionally two dowel recesses, in particular flat dowel recesses 1B or round dowel recesses 1D, for the partial receiving of a respective dowel, in particular of the flat dowel 53B. Alternatively, the dowel recesses can be designed as round dowel recesses 1D (cf. FIG. 11) The connector recess by way of example comprises the connector hole 45 and in particular no access hole 48. The connector recess represents a recess with a connector hole. In particular, the connector recess which has no access hole represents a connector hole. The second workpiece 2B further comprises a second workpiece surface 44B which by way of example is aligned orthogonally to the first workpiece surface 43B and in particular is connected to the first workpiece surface 43B via a common edge 61.

The workpiece arrangement 30 can be brought into an assembled state in which the first workpiece 2A is connected to the second workpiece 2B via the connector 53, in particular the rotary connector 53A and/or one or more flat dowels 53B (or round dowels 53C), in particular in a manner such that the second workpiece 2B is fixed relative to the first workpiece 2A, in particular in all spatial directions, and/or that the second workpiece 2B with its first workpiece surface 43B bears on the first workpiece surface 43A of the first workpiece 2A, in particular in an extensive manner. In the assembled state, the connector 53, in particular the rotary connector 53A is inserted in a recess 1, by way of example the rotary connector recess 1A, of the first workpiece 2A and in a recess 1, by way of example the rotary connector recess 1C, of the second workpiece 2b. Moreover, the further connectors 53, by way of example the flat dowels 53B (or the round dowels 53C) are inserted into the flat dowel recesses 1B (or the flat dowel recesses 1D) of both workpieces 2A, 2B. By way of example, for fastening the second workpiece 2B onto the first workpiece 1A, the complete rotary connector 53A in a state in which it is inserted at least into the rotary connector recess 1A of the first workpiece 2A is rotated by way of the tool 56 and specifically by way of the tool 56 being brought into engagement with the actuation section 55 through the access hole 48 and the tool 56 (and by way of this the complete rotary connector 53A) being rotated about a rotation axis which runs parallel to the y-direction so that at least one engagement projection 57, by way of example two engagement projections 57 are brought into engagement with the rotary connector recess 1C (in particular with undercuts 46) of the second workpiece 2B, wherein at least one engagement projection 57 by way of example two engagement projections 57 are engaged with the rotary connector recess 1A (in particular with undercuts 46) of the first workpiece 2A.

The geometries of the different recesses 1 which can be manufactured with the connector milling machine 10 are dealt with hereinafter.

Firstly regarding the dowel recesses:

Each dowel recess by way of example has shape of a cylinder. In particular, the cross section of each dowel recess is constant along the respective cylinder axis (which by way of example is aligned parallel to the depth direction z). Each dowel recess runs out (in particular exclusively) at the respective first workpiece surface 43A, 43B.

Each flat dowel recess 1B comprises a base surface whose outer contour comprises two straight-lined sections 62 which in run parallel and two rounded, in particular circular-arc-shaped end sections 63 which connect the straight-lined sections. Each round dowel recess 1D by way of example has the shape of a circular cylinder. The dowel recess, in particular the flat dowel recess and/or the round dowel recess expediently has no undercut.

The connector milling machine 10 is designed to create the dowel recess, in particular the flat dowel recess 1B and/or the round dowel recess 1D, as the recess 1. In particular, the connector milling machine 10 comprises movement information which is assigned to the dowel recess for creating the dowel recess, in particular movement information which is assigned to the flat dowel recess 1B for creating the flat dowel recess 1B and/or movement information which is assigned to the round dowel recess 1D for creating the round dowel recess 1D.

During the creation of the dowel recess, in particular the flat dowel recess 1B and/or the round dowel recess 1D, the connector milling machine 10 carries out a creation procedure with the movement information which is assigned to the dowel recess to be created and herein according to the movement information moves the milling tool 17 (carrying out the material-removing movement) in the width direction x and transverse direction y for the definition of the cross section of the dowel recess and in the z-direction for the definition of the extension of the dowel recess along the cylinder axis.

Next, the rotary connector recess 1A is dealt with. The rotary connector recess 1A can also be denoted as a rotary connector recess of the first type.

The rotary connector recess 1A comprises the connector hole 45 which preferably comprises at least one undercut 46. By way of example, the connector hole 45 comprises two undercuts 46. The connector hole 45 preferably comprises a main section 64 which expediently has the shape of a circular disc section and serves for the at least partial receiving of the connector body 54. The main section 64 with its disc plane is aligned orthogonally to the first workpiece surface 43A and/or orthogonally to the transverse direction y. The main section 64 runs out at the first workpiece surface 43A of the first workpiece 2A, in particular exclusively at the first workpiece surface 43A of the first workpiece 2A. Each undercut 64 by way of example has an arc-shaped, in particular circular-arc-shaped course. Expediently, each undercut 46 is designed in the manner of a ring section. Each undercut 46 by way of example is circumferential around an axis which is aligned parallel to the transverse direction y, in particular a ring axis, and/or is aligned concentrically to the main section 64. By way of example, an undercut 46 connects onto the main section 45 in the positive transverse direction y and a further undercut 46 connects onto the main section 45 in the negative transverse direction y. Each undercut 46 runs out of the workpiece 2A at the first workpiece surface 43A, in particular exclusively at the first workpiece surface 43A.

The rotary connector recess 1A comprises the access hole 48 which by way of example is designed in a cylindrical manner and expediently coming from the main section 45 runs to the second workpiece surface 44A along the transverse direction y and runs out at this second workpiece surface. The cylinder axis of the access hole 48 is aligned by way of example parallel to the y-direction. The access hole 48 expediently also runs out at the first workpiece surface 43A of the first workpiece 2A and by way of example breaks through the common edge 61 of the first workpiece 2A.

The connector milling machine 10 is designed to create the rotary connector recess 1A as the recess 1. In particular, the connector milling machine 10 comprises movement information which is assigned to the rotary connector recess 1A for creating the rotary connector recess.

During the creation of the rotary connector recess 1A, the connector milling machine 10 carries out a creation procedure with the movement information which is assigned to the rotary connector recess 1A to be created and herein displaces the milling tool 17 (carrying out the material-removing movement) according to the movement information in the width direction x, the transverse direction y and the depth direction z for the definition of the recess geometry of the rotary connector recess 1A.

The rotary connector recess 1C which can also be denoted as the rotary connector recess of the second type is dealt with next.

The rotary connector recess 1C is expediently designed as the rotary connector recess 1A with the difference that the rotary connector recess 1C has no access hole and by way of example is present on the second workpiece 2B. Inasmuch as this is concerned, the above explanations which relate to the rotary connector recess of the first type apply to the rotary connector recess of the second type, wherein the references to the first workpiece surface 43A are to be replaced by the references to the first workpiece surface 43B.

The connector milling machine 10 is designed to create the rotary connector recess 1C as the recess 1. In particular, the connector milling machine 10 comprises movement information which is assigned to the rotary connector recess 1C, for creating the rotary connector recess.

During the creation of the rotary connector recess 1C, the connector milling machine 10 carries out a creation procedure with the movement information which is assigned to the rotary connector recess 1C to be created and herein displaces the milling tool 17 (carrying out the material-removing movement) according to the movement information in the width direction x, the transverse direction y and the depth direction z for the definition of the recess geometry of the rotary connector recess 1C.

FIGS. 12 to 16 show a workpiece arrangement 40 which comprises a first workpiece 2A and a second workpiece 2B as well as a connector 53 which by way of example is designed as a kinematic connector 53D.

The kinematic connector 53D comprises a connector body 54 as well as an actuation section 55 which is arranged on the connector body 54 (and movably mounted, in particular rotatably mounted, relative to this) and which by way of example comprises an in particular hexagonal recess, into which in particular the tool 56 which is designed for example as an inner hex can be inserted. The kinematic connector 53D further comprises engagement projections 57 which are arranged on the connector body 54 and are movably mounted relative to this. The engagement projections 57 are kinematically connected to the actuation section 55, for example via one or more cam gears, in particular in manner such that the engagement projections 57 can be selectively brought into an engagement position or an insertion position via a movement, in particular a rotation, of the actuation section 55. In the engagement position, the engagement projections 57 project further from the connector body 54 than in the insertion position, in particular along the transverse direction y, thus expediently in the positive and/or negative transverse direction y. By way of example, four engagement projections 57 are present, wherein two engagement projections 57 are present on each end of the kinematic connector 53D which is situated along the depth direction z, said engagement projections expediently being distanced further from one another (in particular along the transverse direction y) in the engagement position than in the insertion position.

The first workpiece 2A comprises a first workpiece surface 43A, in which by way of example a recess 1 is present and specifically a kinematic connector recess 1E for the partial receiving of the kinematic connector 53D. The kinematic connector recess 1E by way of example comprises the connector hole 45 and the access hole 48. The first workpiece 2A further comprises a second workpiece surface 44A which by way of example is aligned orthogonally to the first workpiece surface 43A of the first workpiece 2A and is connected to the first workpiece surface 43 A of the first workpiece 2A in particular via a common edge 61 of the first workpiece 2A.

The second workpiece 2B comprises a first workpiece surface 43B, in which by way of example a recess 1 is present, and specifically a kinematic connector recess 1F, for the partial receiving of the kinematic connector 53D. The kinematic connector recess 1F by way of example comprises the connector hole 45 and in particular no access hole 48. The second workpiece 2B further comprises a second workpiece surface 44B which by way of example is aligned orthogonally to the first workpiece surface 43B of the second workpiece 2B and in particular is connected to the first workpiece surface 43B of the second workpiece 2B via a common edge 61 of the second workpiece 2B.

The workpiece arrangement 40 can be brought into an assembled state by way of the first workpiece 2A being connected to the second workpiece 2B via the kinematic connector 53D, in particular in a manner such that the second workpiece 2B is fixed relative to the first workpiece 2A, in particular in all spatial directions, and/or that the second workpiece 2B with its first workpiece surface 43B bears on the first workpiece surface 43A of the first workpiece 2A, in particular in an extensive manner. In the assembled state, the kinematic connector 53D is inserted in the kinematic connector recess 1E of the first workpiece 2A and in the kinematic connector recess 1F of the second workpiece 2B. For inserting the kinematic connector 53D into the two kinematic connector recesses 1E, 1F, by way of example the engagement projections 57 are firstly in the insertion position. By way of example, for fastening the second workpiece 2B onto the first workpiece 1A, in a state in which the kinematic connector 53D is inserted into the kinematic connector recess 1E of the first workpiece 2A and into the kinematic connector recess 1F of the second workpiece 2B, the actuation section 55 is actuated, in particular rotated, relative to the connector body 54 by way of the tool 56 and specifically preferably by way of the tool 56 being brought into engagement with the actuation section 55 through the access hole 48 and the tool 56 (and by way of this the actuation section 55) being rotated about a rotation axis which runs parallel to the y-direction, in order to provide the engagement position, so that at least one engagement projection 57, by way of example two engagement projections 57 is/are brought into engagement with the kinematic recess 1E (in particular with undercuts 46) of the first workpiece 2A and that at least one engagement projection 57, by way of example two engagement projections 57, is/are brought into engagement with the kinematic recess 1F (in particular with undercuts 46) of the second workpiece 2B.

The kinematic connector recess 1E can also be denoted as a kinematic connector recess of the first type.

The kinematic connector recess 1E comprises the connector hole 45 which preferably comprises at least one undercut 46. By way of example, the connector hole 45 comprises two undercuts 46. The connector hole 45 comprises preferably a main section 64 which serves for the at least partial receiving of the connector body 54. The main section 64 runs out at the first workpiece surface 43A, in particular exclusively at the first workpiece surface 43A, of the first workpiece 2A. The main section 64 by way of example has the shape of a cylinder. In particular, the x-y cross section of the main section 64 is constant along the cylinder axis (which by way of example is aligned parallel to the depth axis z). The main section 64 comprises the x-y section with which the main section 64 runs out at the first workpiece surface 43A of the first workpiece 2A and/or its outer contour comprises two straight-lined sections 65 which run in parallel and two rounded, in particular circular-arc-shaped end sections 66 which connect the straight-lined sections 65. The x-y cross section in particular is designed in an elongate manner and is expediently aligned with its longitudinal axis parallel to the width direction x. Each undercut 46 by way of example has a straight course. Expediently, each undercut 46 is designed cylindrically, in particular with a cylinder axis which is aligned parallel to the depth direction z. Preferably, each undercut 46 has a cross section (in particular x-y cross-section) which is designed as a polygon, for example as a rectangle, parallel to the cylinder axis of the main section 64 (for example parallel to the depth direction z). For example, the cross section comprises one or more chamfers, for example to the connector hole base 47 and/or to the main section 64. In particular, each undercut 46 is designed as an elongate cut-out, wherein the longitudinal axis of the elongate cut-out is aligned parallel to the width direction x. By way of example, an undercut 45 connects onto the main section 45 in the positive transverse direction y and a further undercut 46 connects onto the main section 45 in the negative transverse direction y. Expediently, the distance of each undercut 46 to the first workpiece surface 43, on which the connector milling machine 10 bears with the contact structure 8 on creating the recess 1, is constant along an extension direction of the connector hole 45 which is aligned orthogonally to the rotation axis of the material-removing movement. The extension direction is for example the width direction x. Expediently, the distance of each undercut 46 to the first workpiece surface 43A of the first workpiece 2A is constant over the (in particular complete) x-extension of the kinematic connector recess 1E. Optionally, the z-extension (thus in particular the depth) of the connector hole 45 is constant over the complete x-extension of the connector hole 45. The x-extension is the extension in the width direction x.

The kinematic recess 1E comprises the access hole 48 which by way of example is designed cylindrically and expediently coming from the main section 45 runs along the transverse direction y to the second workpiece surface 44A of the first workpiece 2A and runs out at this second workpiece surface. The cylinder axis of the access hole 48 by way of example is aligned parallel to the y-direction. The access hole 48 expediently also runs out at the first workpiece surface 43A of the first workpiece 2A and by way of example breaks through the common edge 61 of the first workpiece 2a.

The connector milling machine 10 is designed to create the kinematic connector recess 1E as the recess 1. In particular, the connector milling machine 10 comprises movement information which is assigned to the kinematic connector recess 1E, for creating the kinematic connector recess 1E.

During the creation of the kinematic connector recess 1E, the connector milling machine 10 carries out a creation procedure with the movement information which is assigned to the kinematic connector recess 1E to be created and herein displaces the milling tool 17 (carrying out the material-removing movement) according to the movement information, in the width direction x, the transverse direction y and the depth direction z for the definition of the recess geometry of the kinematic connector recess 1E.

The kinematic connector recess 1F which can also be denoted as a kinematic connector recess of the second type is to be dealt with next.

The kinematic connector recess 1F is expediently designed as the kinematic connector recess 1E, with the difference that the kinematic connector recess 1F has no access hole and by way of example is present on the second workpiece 2B. Optionally, the kinematic connector recess 1F has a lower extension in the depth direction z than the kinematic connector recess 1E. Inasmuch as this is concerned, the aforementioned explanations which are directed to the kinematic connector recess of the first type also apply to the kinematic connector recess of the second type, wherein references to the first workpiece surface 43A of the first workpiece 2A are to be replaced by references to the first workpiece surface 43B of the second workpiece 2B.

The connector milling machine 10 is designed to create the kinematic connector recess 1F as the recess 1. In particular, the connector milling machine 10 comprises movement information which is assigned to the kinematic connector recess 1F, for creating the kinematic connector recess 1F.

During the manufacture of the kinematic connector recess 1F, the connector milling machine 10 carries out a creation procedure with the movement information which is assigned to the kinematic connector recess 1F to be created and herein displaces the milling tool 17 (carrying out the material-removing movement) according to the movement information, in the width direction x, the transverse direction y and the depth direction z for the definition of the recess geometry of the kinematic connector recess 1F.

Preferably, the connector milling machine 10 comprises movement information which is assigned to the flat dowel recess 1B and/or movement information which is assigned to the round dowel recess 1D and/or movement information which is assigned to the rotary connector recesses 1A and/or movement information which is assigned to the rotary connector recess 1C and/or movement information which is assigned to the kinematic connector recess 1E and/or movement information which is assigned to the kinematic connector recess 1F.

A connector milling machine 20 according to the second embodiment is dealt with hereinafter. An exemplary design of the connector milling machine 20 is shown in the FIGS. 6 to 9. Preferably, the connector milling machine 20 is formed as the connector milling machine 10 with the exception of the subsequently explained differences, so that inasmuch as this is concerned the explanations related to the connector milling machine 10 also apply to the connector milling machine 20.

Optionally, concerning the connector milling machine 20, the first positioning degree of freedom 31 is a pivoting degree of freedom, in particular about a pivot axis which runs in the transverse direction y. Alternatively, the first positioning degree of freedom 31 can also be a linear positioning degree of freedom which runs in the width direction x (as with the first embodiment).

The connector milling machine 20 comprises the second linear drive 34B which serves for providing the second positioning degree of freedom 32 which runs in the transverse direction y, for the positioning of the milling tool 17.

Concerning the connector milling machine 20, the housing 3 is designed in an elongate manner and is aligned with its longitudinal axis in the z-direction. A housing section of the housing 3 which is to the rear in the z-direction, thus in particular of the side which is away from the contact device 6, by way of example forms the handle 4. In particular, this housing section is dimensioned in a manner such that it can be embraced by one hand.

The housing 3 together with the electrical drive device 27 and the milling tool 17 forms a housing subassembly which is expediently mounted relative to the contact device 6 in a linearly movable manner in the depth direction z. The positioning device 18 is designed to move the housing subassembly relative to the contact device 6, preferably by way of the linear drive 34C in order to position the milling tool 17 along the third positioning degree of freedom 33. By way of example, the linear drive 34C comprises an electric motor 38 which belongs to the housing subassembly and a guide element 35C which is designed for example as a rack and which is coupled to the contact device 6. A relative linear movement between the electric motor 38 and the guide element 35C can be effected by a drive which is provided by the electric motor 38, in order by way of this to provide the positioning along the third positioning degree of freedom 33.

Optionally, the connector milling machine 20 comprises a suction channel 39 via which particles, in particular chippings which arise on creating the recess 1 can be sucked away.

By way of example, the fixation device comprises structure section guide elements 41 which are preferably designed as slotted guides. By way of example, the structure section guide elements 41 are fastened to the second structure section 11 and are co-pivoted with this about the pivot axis 15. Preferably, the structure section guide elements 41 define the pivot axis 15 or contribute to the definition of the pivot axis 51. The structure section guide elements 41 in particular can be seen as being part of the pivot bearing. The fixation device preferably comprises an actuation element 42 which by way of example is designed as a lever and via whose actuation the second structure section 11 can be fixed in its current pivot position relative to the first structure section 9, for example by way of a non-positive fit and/or positive fit, in particular by way of at least one structure section guide element 41 being fixed in its current pivot position relative to the first structure section 9, for example by way of a non-positive fit and/or positive fit, by way of the actuation element 42.

A method for the operation of the hand-held connector milling machine, in particular of the connector milling machine 10 or the connector milling machine 20 is described hereinafter.

The method comprises a step, regarding which the connector milling machine 10, 20 is positioned on the workpiece 2, in particular such that the connector milling machine 10, 20 (in particular during the creation of the recess 1) bears with the contact structure 8 on the workpiece 2 in a stationary manner.

The method comprises a further step, regarding which the electrical positioning device 18 is controlled according to the movement information (in particular by the control unit 37) so that the electrical positioning device 18 brings the milling tool 17 into the movement sequence whilst the milling tool 17 carries out the rotative material-removing movement, in order to create the recess 1 which comprises the connector hole 45, with the recess geometry which is specified (in particular by the movement sequence).

Preferably, the connector milling machine 10, 20 bears with the contact structure 9, in particular simultaneously with both structure sections 9, 11, on the workpiece 2 in a stationary manner during the complete movement sequence. Expediently, the connector hole 45 as well as the access hole 48 is created with the movement sequence. Preferably, no repositioning of the connector milling machine 10, 20 relative to the workpiece is effected between the creation of the connector hole 45 and the creation of the access hole 48.

Preferably, the recess 1 comprises the connector hole 45 which extends along the width direction x and runs out at the first workpiece surface 43 of the workpiece 2, as well as the access hole 48 which extends along the transverse direction y which is directed orthogonally to the width direction x, from the connector hole 45 to the second workpiece surface 44 of the workpiece 2 and runs out at this second workpiece surface 44. Preferably, the connector milling machine 10, 20 simultaneously bears with both structure sections 9, 11 on the workpiece 2 in a stationary manner during the execution of the complete movement sequence with which the connector hole 45 as well as the access hole 48 is created.

Preferably, the milling tool 17 is moved through the pivot axis 15 on creation of the access hole 48.

Optionally, after the creation of the recess 1, a connector 53 is inserted into the recess 1, in particular into the connector hole 45, in particular after completion of the creation of the recess 1.

The connector 53 which is inserted into the connector hole 45 is preferably one of the previously described connectors, for example the rotary connector 53A or the flat dowel 53B or the round dowel 53C or the kinematic connector 53D.

Optionally, the workpiece arrangement 30 or the workpiece arrangement 40 is created with the workpiece 2 (as the first workpiece 2a).

Preferably, the connector milling machine 10, 20 creates the access hole 48 starting from the first workpiece surface 43, so that preferably no drilling template (in particular for creating the access hole 48) is necessary. For example (in particular as the connector milling machine 10, 20) a dowel milling machine or a router is provided, with which the access hole 48 (which for example is a transverse groove) is to be created, in particular in a predefined relative position to the connector hole 45 (which is designed for example as a coupling groove). Alternatively, an industrial CNC milling machine can be provided for creating the access hole 48 (in particular the transverse groove) and the connector hole (in particular the coupling groove).

For example, firstly a first recess, in particular one of the previously explained recesses 1 is created in the first workpiece surface 43 with the connector milling machine 10, 20 whilst the connector milling machine 10, 20 bears with the contact device 6 on the first workpiece surface 43 in a stationary manner. The connector milling machine 10, 20 is subsequently repositioned by hand, for example onto the first workpiece surface 43 or onto another workpiece surface. A second recess is subsequently created with the connector milling machine 10, 20 whilst the connector milling machine 10, 20 bears with the contact device 6 on the first workpiece surface or the other workpiece in a stationary manner. The second recess in particular is one of the recesses 1 which is explained above. The second recess expediently differs from the first recess. The second recess is created on the first workpiece surface 43 or on the second workpiece surface.

Optionally, the first recess 1 and the second recess are identical, for example the first recess and the second recess each comprise a respective connector hole 45 and a respective access hole 48. For example, the first recess is created on the first workpiece surface of a first workpiece and the second recess on the first workpiece surface of a second workpiece. For example, on creation of the first recess, the connector milling machine 10, 20 simultaneously bears with the contact device 6 on the first workpiece surface and on a second workpiece surface, of the first workpiece, wherein the angle 12 is preferably larger than 90 degrees. For example, on manufacture of the second recess, the connector milling machine 10, 20 simultaneously bears with the contact device 6 on the first workpiece surface and a second workpiece surface, of the second workpiece, wherein the angle 12 is preferably larger than 90 degrees.

1. A hand-held connector milling machine for creating a recess in a workpiece, wherein the recess comprises a connector hole for an at least partial receiving of a connector, wherein the connector milling machine comprises:
a handle for gripping the connector milling machine and for positioning the connector milling machine relative to the workpiece,
a contact device with a contact structure for a stationary bearing contact of the connector milling machine on the workpiece during the creation of the recess,
a milling tool,
an electrical drive device which is designed to bring the milling tool into a rotative material-removing movement,
an electrical positioning device which is designed to move the milling tool relative to the contact structure along at least two positioning degrees of freedom, and
an electronic control unit which is designed to control the electrical positioning device according to movement information, so that the electrical positioning device brings the milling tool into a movement sequence which is defined by the movement information, along the at least two positioning degrees of freedom whilst the milling tool carries out the rotative material-removing movement, in order to create a recess with the connector hole with a predefined recess geometry.

2. The connector milling machine according to claim 1, wherein one of the positioning degrees of freedom runs in the axis direction of the rotation axis of the material-removing movement and/or orthogonally to a contact plane which is defined by the contact structure.

3. The connector milling machine according to claim 1, wherein one of the positioning degrees of freedom runs orthogonally to the rotation axis of the material-removing movement and/or parallel to a contact plane which is defined by the contact structure.

4. The connector milling machine according to claim 1, wherein the positioning device is designed to displace the milling tool relative to the contact structure along three positioning degrees of freedom, wherein the positioning degrees of freedom.

5. The connector milling machine according to claim 4, wherein the movement information defines the movement sequence along the three positioning degrees of freedom and the movement sequence specifies the recess geometry with respect to the three positioning degrees of freedom.

6. The connector milling machine according to claim 1, wherein a maximal displacement path for the positioning of the milling tool along a positioning degree of freedom which runs in a width direction is at least 1.3 cm and/or a maximal displacement path for the positioning of the milling tool along a positioning degree of freedom which runs in a transverse direction is at least 0.4 cm and/or a maximal displacement path for the positioning of the milling tool along a positioning degree of freedom which runs in the depth direction is at least 1.1 cm.

7. The connector milling machine according to claim 1, wherein the movement sequence specifies a recess geometry, in which the connector hole to be created comprises an undercut which acts along a depth direction which is aligned parallel to the rotation axis of the material-removing movement.

8. The connector milling machine according to claim 7, wherein the undercut is arranged in the region of a connector hole base of the connector hole.

9. The connector milling machine according to claim 7, wherein the distance of the undercut to a first workpiece surface on which the connector milling machine bears with the contact structure on creation of the recess is constant along an extension direction of the connector hole which is aligned orthogonally to the rotation axis of the material-removing movement.

10. The connector milling machine according to claim 1, wherein the movement sequence which is defined by the movement information specifies the connector hole and an access hole to the connector hole, wherein the electronic control unit is designed to control the electrical positioning device according to the movement information such that the electrical positioning device brings the milling tool into the movement sequence whilst the milling tool carries out the rotative material-removing movement, in order to create the connector hole and the access hole.

11. The connector milling machine according to claim 1, wherein the electronic control unit comprises several different pieces of movement information, wherein each piece of movement information is assigned to a respective recess geometry, wherein the recess geometries differ from one another and wherein the control unit is designed to control the positioning device according to one of the pieces of movement information, in order to effect the creation of the recess with the recess geometry which is assigned to this piece of movement information.

12. The connector milling machine according to claim 11, wherein the several pieces of movement information comprise a first piece of movement information which is assigned to a first recess geometry, in which the connector hole comprises an undercut, and a second piece of movement information which is assigned to a second recess geometry, in which the connector hole has no undercut.

13. The connector milling machine according to claim 1, comprising a housing on which the handle is arranged, wherein the extension of the housing in a width direction which is aligned orthogonally to the rotation axis of the material-removing movement is larger than the extension of the housing in the direction of the rotation axis.

14. The connector milling machine according to claim 1, wherein the contact structure comprises a first structure section and a second structure section for the simultaneous stationary bearing contact on the workpiece during the creation of the recess with the connector hole, wherein the first structure section defines a first contact plane and the second structure section defines a second contact plane, and wherein the second structure section is pivotably mounted relative to the first structure section and can be fixed in a plurality of different pivot positions relative to the first structure section, in order to set, between the contact planes, a fixed angle which is adapted to the workpiece.

15. The connector milling machine according to claim 14, wherein the second structure section is pivotably mounted relative to the first structure section about a pivot axis and the pivot axis intersects a displacement region of the milling tool which is formed by the at least two positioning degrees of freedom.

16. A method for the operation of a hand-held connector milling machine according to claim 1, comprising the steps:
positioning the connector milling machine on the workpiece such that the connector milling machine bears with the contact structure on the workpiece in a stationary manner during the creation of the recess,
controlling the electrical positioning device according to the movement information so that the electrical positioning device brings the milling tool into the movement sequence whilst the milling tool carries out the rotative material-removing movement, in order to create the recess which comprises the connector hole, with the predefined recess geometry.

17. The method according to claim 16, wherein the connector milling machine bears with the contact structure on the workpiece in a stationary manner during the complete movement sequence.

18. The method according to claim 16, wherein the connector hole runs out at a first workpiece surface of the workpiece and extends along a width direction and the recess further comprises an access hole, said access hole extending from the connector hole to a second workpiece surface of the workpiece along a transverse direction which is aligned orthogonally to the width direction, and running out at this second workpiece surface, and wherein the connector milling machine simultaneously bears with the contact structure on the workpiece in a stationary manner during the execution of the complete movement sequence with which the connector hole as well as the access hole is created.

19. The method according to claim 16, further comprising the step: inserting a connector into the connector hole.

20. The connector milling machine according to claim 4, wherein the three degrees are linear degrees of freedom and are aligned orthogonally to one another.
